(19) United States
(12) Patent Application Publication
(10) Pub. No.: US 2004/0121082 A1
(43) Pub. Date: Jun. 24, 2004

(54) Method and apparatus for producing multi-color concrete

(76) Inventors: Jack Dunnous, Philadelphia, PA (US); William J. Yocum, Souderton, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(21) Appl. No.: 10/624,810

(22) Filed: Jul. 22, 2003

Related U.S. Application Data
(60) Provisional application No. 60/420,250, filed on Oct. 22, 2002.

(51) Int. Cl. B05D 1/02; B05D 5/00

(52) U.S. Cl. 427/421; 427/256; 118/300

(57) ABSTRACT

A method for producing multi-color concrete is provided which includes the steps of providing a pigment water dispersion, providing a polymer binding agent, mixing the pigment water dispersion and the polymer binding agent to form a first spray color dispersion, discharging a wet concrete mix from a vessel, spraying the first spray color dispersion onto the wet concrete mix discharging from the vessel to form a pattern of applied color in the wet concrete mix, and forming a resultant structure of cured concrete. A system for coloring concrete based on the above method is also provided.

### CROSS-REFERENCE TO RELATED APPLICATION

This application claims the benefit of U.S. Provisional Patent Application 60/420,250, filed Oct. 22, 2002, entitled Method and Apparatus for Producing Multi-Color Concrete.

### BACKGROUND OF THE INVENTION

Masonry of multi-color concrete is a unit constructed of concrete which contains a base color (which may be the natural color of the concrete). Another color is superimposed over the base color with partial blending so that a random pattern is achieved to simulate the variegation of various natural stones and marbles. In certain cases, two colors are superimposed over the base for a more random look. In the past, this effect has generally been achieved by one of two methods.

In the first method, small batches of different color concrete mixes are first prepared. Subsequently, using a special technique, partial intermixing of the batches is performed, typically in a special hopper. For example, for a three color masonry unit, three batches, each of a quantity of one-third of the total required amount is fed sequentially to the hopper. The masonry is then poured into a mold. A somewhat similar process is described in U.S. Pat. No. 5,248,338 (Price). This patent is directed to colored marbled concrete and a process of producing colored marbled concrete. Dye is mixed into the primary mix and accent colors are added to the primary mix to create a marbled effect. Here, sand, cement, and water are mixed in a mixing vessel until uniform and homogeneous. Concrete, mortar, or tile grout dye is then added to the mix for the primary color selected. One or more accent colors are mixed in the same proportions as the primary mix, but in smaller batches. The color mix and the primary mix and the accent color mix are poured into a mold and sparingly stirred to provide a multi-color effect.

In the second method, a second color is added into a mixer which already has a concrete batch with a base color. A short mix time is provided thereafter so that the second color is not thoroughly mixed, thereby developing a random pattern.

Other known method include various combinations of the above two processes.

These methods have certain disadvantages. The first method above requires small mix batches, for example one-half or one-third size batches, which require more batches to be produced, thus slowing down production and increasing costs. The second method above requires particular skills. For example, an operator is required to know when to introduce the second color, the location in the mixer the color is to be injected, and how long or short the mix should be. In both cases, the results are dependent on the operator skill and are not reliably replicated.

Objects of the present invention include achieving a random coloring pattern in concrete that uses full batches such that the method is cost effective and provides for easy replication.

Other known related patents include the following:

U.S. Pat. No. 5,476,722 (Sakamoto et al.) is directed to a concrete coloring material and a process for coloring concrete. Here, a concrete penetration layer of polyethylene oxide is deposited on a concrete substrate prior to drying. The polyethylene oxide is dissolved in water contained in the concrete so that dye in the penetration layer penetrates into the surface of the concrete, resulting in coloring the concrete.

U.S. Pat. No. 4,050,864 (Komaki) is directed to an apparatus for manufacturing concrete panels with surface pattern decorations. Here, the apparatus comprises a mortar hopper having a mortar outlet opening and a mortar chute extending downward from beneath the outlet opening of the hopper. A molding surface is positioned below the mortar chute and the mortar chute extends to the molding surface. Color mortar containers disposed above the mortar chute discharge (pour) color mortar materials while making a reciprocating motion. A mixing means incompletely mixes the mortar with the color mortar materials on the mortar chute.

U.S. Pat. No. 5,534,214 (Sakamoto et al.) is directed to a concrete coloring material and a process for coloring concrete using the coloring material. Polyethylene oxide is used as a water-soluble adhesive. The oxide is mixed with a dye or pigment to permit the composition to penetrate into the concrete.

U.S. Pat. No. 5,993,551 (Hahn) is directed to a roof tile as well as a method and apparatus for making the roof tile. Multiple spray nozzles dispense a coating liquid, prior to drying, in random patterns. Spraying is accomplished by a computer controlled spray system which includes banks of spray guns which spray liquid on the surface of clay tiles.

U.S. Pat. No. 4,975,303 (McKinnon) is directed to a process for covering a substrate with a textured, simulated marble surface and the resulting simulated marble product. Here, cement and sand are mixed to form a first mixture to which an adhesive resin is added to create a mortar. The mortar is spread on the substrate and one or more color pigments are added to the surface at randomly-spaced locations prior to complete curing of the mortar. Air is blown onto the surface of the mortar and serves to blend the color pigments into the mortar and into each other. As the air stream moves across the surface of the mortar, color patterns are formed.

### BRIEF DESCRIPTION OF SEVERAL VIEWS OF THE DRAWINGS

The invention will be described in conjunction with the following drawings in which like reference numerals designate like elements and wherein:

FIG. 1 is a schematic diagram of a multi-color spray system for producing multi-color concrete in accordance with one preferred embodiment of the present invention; and

FIG. 2 is an example of a control panel of the multi-color spray system of FIG. 1.

### BRIEF SUMMARY OF THE INVENTION

A method for producing multi-color concrete is provided which includes the steps of providing a pigment water dispersion, providing a polymer binding agent, mixing the pigment water dispersion and the polymer binding agent to form a first spray color dispersion, discharging a wet concrete mix from a vessel, spraying the first spray color dispersion onto the wet concrete mix discharging from the vessel to form a pattern of applied color in the wet concrete mix, and forming a resultant structure of cured concrete.

The step of spraying may include using at least one nozzle to spray the first spray color dispersion under pressure. The method may include the additional steps of providing a second pigment water dispersion, providing a second polymer binding agent, mixing the second pigment water dispersion and the second polymer binding agent to form a second spray color dispersion, and spraying the second spray color dispersion onto the wet concrete mix. Here, the steps of spraying may include using a plurality of nozzles, wherein at least one nozzle sprays the first spray color dispersion and at least one nozzle sprays the second spray color dispersion. A step of controlling a color pattern using timers that controls the step of spraying may also be provided. The step of controlling the color pattern may include spraying in pulses such that sprays of various lengths of time produce a desired pattern. The step of spraying may include using at least one nozzle having a desired flow pattern. For example, the step of spraying may include using at least one nozzle that produces a pattern of a solid cone, a hollow cone, or a flat spray. The step of spraying may include spraying in the form of a stream. The step of spraying may include varying the distances between the nozzle and the wet concrete mix.

A method for producing multi-color concrete is also provided that includes the steps of providing a pigment water dispersion, providing a polymer binding agent capable of integrally binding with wet concrete mix to form an irreversible integral structure of the pigment and the concrete, mixing the pigment water dispersion and the polymer binding agent to form a first spray color dispersion, discharging a wet concrete mix from a vessel, spraying the first spray color dispersion onto the wet concrete mix, discharging from the vessel to form a pattern of applied color in the wet concrete mix, and forming a resultant structure of cured concrete. A resultant polymer structure is insoluble in water and remains as part of the cured concrete, thereby preserving the integrity of the pattern of applied color highlight.

The step of providing the polymer binding agent may include providing at least one of water borne urethane, acrylic emulsions, water soluble acrylic polymers, water soluble vinyl acetate, acrylic colloids, styrene acrylic resins, styrene acrylic resins solutions, and acrylic copolymer latexes.

The step of mixing may include mixing at least one filler to produce a desired effect. The step of spraying may include using at least one nozzle to spray the first spray color dispersion under pressure. The method may further include the steps of providing a second pigment water dispersion, providing a second polymer binding agent, and mixing the second pigment water dispersion and the second polymer binding agent to form a second spray color dispersion. Here, the steps of spraying may include using a plurality of nozzles, wherein at least one nozzle sprays the first spray color dispersion and at least one nozzle sprays the second spray color dispersion. A step of controlling a color pattern using timers that control the step of spraying may be included. Here, the step of controlling the color pattern may include spraying in pulses such that sprays of various lengths of time produce a desired pattern. The step of spraying may include using at least one nozzle having a desired flow pattern. The step of spraying including use of at least one nozzle may include using at least one nozzle that produces a pattern such as a solid cone, a hollow cone, or a flat spray, or a stream.

The step of spraying may include varying the distances between the at least one nozzle and the wet concrete mix. The step of providing a pigment water dispersion may include providing a pigment in a range of about 2% to about 60%. The step of providing the polymer binding agent may include providing the polymer binding agent in a range of about 1% to about 60%.

Finally, a system for coloring concrete may be provided that includes at least one vessel containing a spray color dispersion. The spray color dispersion may include a pigment water dispersion and at least one polymer binding agent, where the polymer binding agent is capable of reacting with wet concrete mix to form an irreversible integral structure of the pigment and the concrete. The system further includes a spray gun associated with each vessel where each spray gun connected to its associated vessel by a conduit. The system still further includes a pump associated with each vessel to move the spray color dispersion contained in the vessel to the spray gun associated with the vessel, an apparatus for moving fresh concrete relative to each spray gun, and a controller for controlling spraying of the spray color dispersion in each vessel through each spray gun.

### DETAILED DESCRIPTION OF THE INVENTION

The present invention is directed to a method for producing multi-color concrete. Wet concrete is prepared in a vessel, for example, in a concrete mixer. One or more spray guns (nozzles), for example, one to three or more guns, are set to spray a spray color dispersion stream under pressure. The guns are located within the discharge region of the vessel, pointing at the exiting wet concrete mix. When the discharge of the mixer starts, one or more selected guns begins spraying the spray color dispersion onto the wet concrete mix that is emerging from the mixer. The spray color dispersion adds a highlight color to the base color already in the wet concrete mix in the mixer. The base color may be the natural color of the concrete or may be colored concrete. Preferably, the exiting wet concrete mix is carried via a conveyor belt to a hopper feeding concrete forming equipment. One, two or more spray nozzles may be selectively positioned over the conveyor belt adding other color patterns to the mix. Since only minimal further mixing occurs, the concrete formed is randomly tinted.

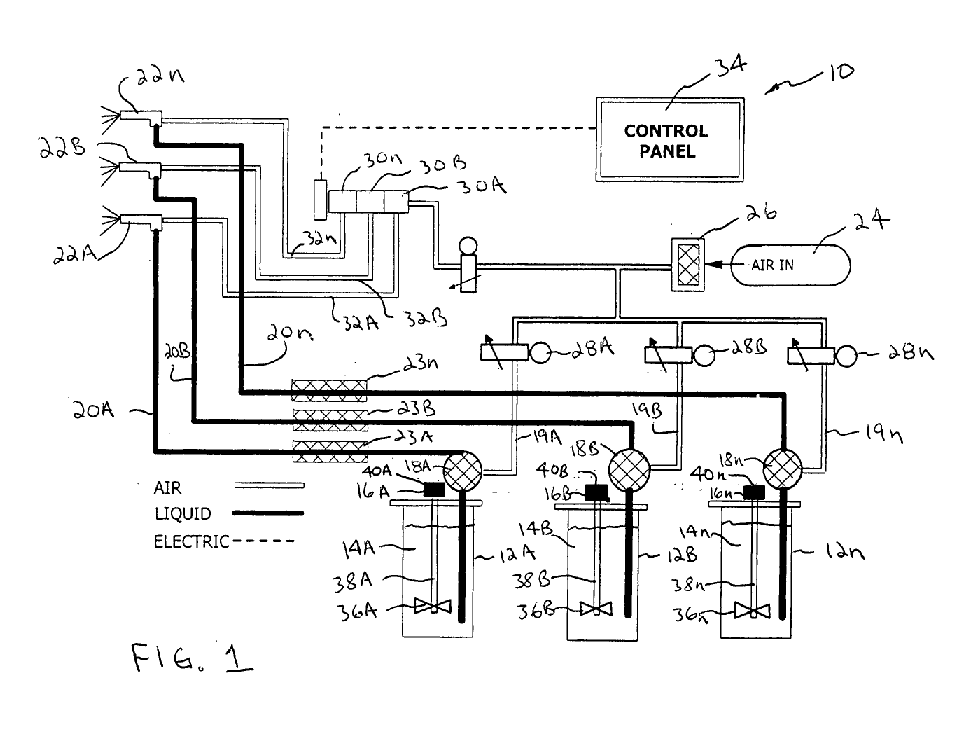

Referring now to the drawings, wherein like part numbers refer to like elements throughout the several views, there is shown in FIG. 1 a multi-color spray system 10 for use in the method for coloring multi-color concrete of one preferred embodiment of the present invention. The multi-color spray system 10 includes at least one vessel 12A, 12B . . . 12n, for containing a spray color dispersion 14A, 14B . . . 14n. Each vessel 12A, 12B, . . . 12n preferably has a mixer 16A, 16B, . . . 16n, such that each spray color dispersion 14A, 14B, . . . 14n is held in suspension during use. Also connected to each vessel 12A, 12B, . . . 12n is a pump 18A, 18B, . . . 18n (preferably an air powered pump) and a liquid conduit 20A, 20B, . . . 20n for pumping each spray color dispersion 14A, 14B, . . . 14n to a spray gun 22A, 22B, . . . 22n. In-line filters 23A, 23B, . . . 23n, or other types of filters known in the art, may be used to ensure the quality of the spray color dispersion 14A, 14B, . . . 14n reaching the spray guns 22A, 22B, . . . 22n.

If air powered pumps 18A, 18B, . . . 18n are utilized, a source of high pressure air provides pressurized air 24, preferably conditioned by lubricator/separator 26, to each pump 18A, 18B, . . . 18n, via pump conduits 19A, 19B, . . . 19n. Pressure regulators 28A, 28B, . . . 28n provide the appropriate pressure desired for each of the pumps 18A, 18B, . . . 18n. The source of high pressure air 24 also, preferably, provides high pressure air to electric air valves 30A, 30B, . . . 30n which, through air conduits 32A, 32B . . . 30n, provide air to activate the spray guns 22A, 22B, . . . 22n. It has been found that a minimum air pressure of about 50 psi and a maximum air pressure of about 80 psi provided to the pumps 18A, 18B, . . . 18n allow the system to operate optimally. A control panel 34, as will be described in greater detail below, may be used to control the electric air valves 32A, 32B, . . . 32n and/or other aspects of the system 10.

Of course, it is anticipated that separate sources of high pressure air may be used to provide pressurized air to activate the spray guns 22A, 22B, . . . 22n (or, for atomization using air, if a spray gun that uses air to atomize the liquid is used) and to the pumps 18A, 18B, . . . 18n.

The spray guns 22A, 22B . . . 22n may be, for example, Model 22AUH by Spraying Systems Company of Wheaton Ill. These are automatic air actuated spray guns that provide a controlled intermittent liquid spray that utilize only liquid pressure as the source for atomization. An internal air cylinder automatically interrupts the liquid flow at any desired frequency up to 180 cycles per second. The specification for these spray guns indicates that a minimum air pressure of 45 psi is required up to a maximum air pressure of 600 psi. These spray guns operate at a capacity of five gallons per minute of liquid. Each spray gun 22A, 22B, . . . 22n may be fitted with one of a number of different nozzle tips, preferably provided by the manufacturer, having various spray angles. Various spray angles and color outputs may be desirable since, for example, belts for carrying concrete vary in width and speed. This preferred type of spray gun is an airless spray gun. That is, the liquid being sprayed is not atomized by air. Of course, any other spray guns or nozzles, known to those skilled in the art may also operate appropriately here, including spray heads that do atomize the liquid being sprayed by mixing with air.

With respect to movement of the spray color dispersion 14A, 14B, . . . 14n, the air powered pumps may be of any type known to those skilled in the art, so long as each is capable providing the spray color dispersion 14A, 14B, . . . 14n through the liquid conduits 20A, 20B, . . . 20n at a pressure within the working range of spray gun. For example, the air powered pump may be a one inch sized air powered diaphragm pump, by, for example, Graco Corporation.

The mixers 16A, 16B, . . . 16n may be a paddle wheel 36a, 36B, . . . 36n connected by a shaft 38A, 38B, 38n to a motor 40A, 40B, . . . 40n. The motor causes the shaft and paddle wheel to rotate at sufficient velocity to keep the spray color dispersions 14A, 14B, . . . 14n fully mixed during operation of the system 10.

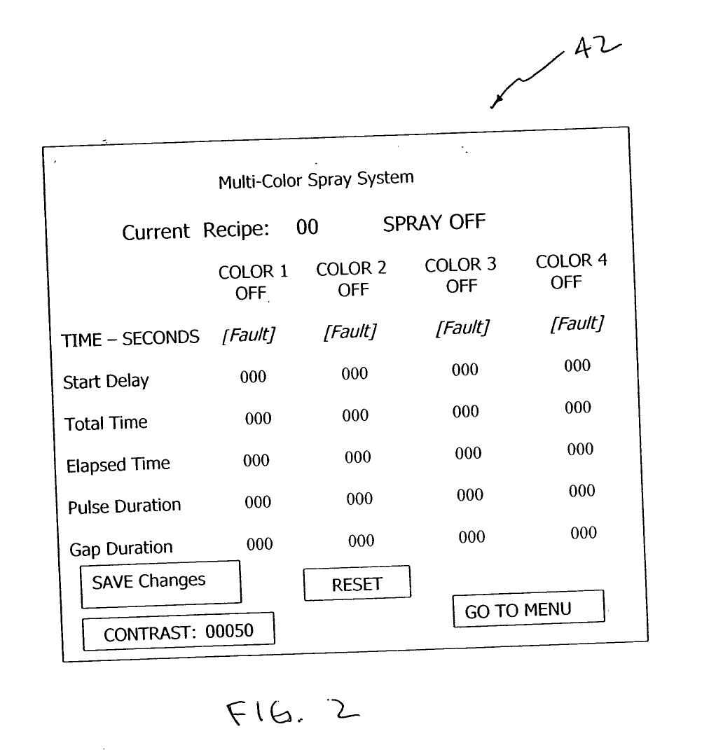

FIG. 2 depicts an example of a display screen 42 of the control panel 34. The display screen 42 is preferably a touch-screen type display screen. In the sample system shown here, first, a “recipe number” is entered on a numeric keypad that appears on the screen which is an arbitrary number assigned to a particular combination of spray dispersions and spray parameters (for use for repeatability). Next, values for various parameters with respect to the spray color dispersions 14A, 14B, . . . 14n are entered. These parameters preferably include: (1) Start Delay, the delay time before the particular spray gun starts spraying, (2) Total Time, the desired spray application time, (3) Elapsed Time, the spray running time set by the timer (no entry required or accepted), (4) Pulse Duration, for when a spray pulse is desired (or zero if pulse is not desired), (5) Gap Duration, for the length of the off cycle of the pulse (or zero if pulse is not desired). The pulsing cycle continues throughout the total cycle time. The display indicates whether the system is operating. A particular set of parameters may be saved for repeatability under the recipe number.

As indicated, preferably, the spray guns 22A, 22B, . . . 22n are directed to wet concrete discharging from a vessel, for example, being transported on a conveyor belt. The vessel may be any container of any type capable of holding wet concrete. However, other wet concrete being poured that is in movement relative to spray heads is also intended to be within the scope of the present invention. Table 1 below depicts examples of a spray width with respect to spray gun height over the wet concrete for various nozzle spray angles and spray gun heights over the conveyor belt. These nozzle sprays are typically available from the spray gun manufacturer. These results shown are examples only and errors of about +/−about 15 percent are possible.

TABLE 1
SPRAY WIDTH, INCHES

| Gun | 25 | 40 | 50 | 65 | 80 | 95 | 110 |
|---|---|---|---|---|---|---|---|
| Height | Deg. | Deg. | Deg. | Deg. | Deg. | Deg. | Deg |
| 12 in. | 5.0 | 8.5 | 11.0 | 15.5 | 20.0 | 26.0 | 34.0 |
| 15 in. | 6.5 | 11.0 | 14.0 | 19.0 | 25.0 | 33.0 | 43.0 |
| 18 in. | 8.0 | 13.0 | 17.0 | 23.0 | 30.0 | 39.0 | 51.0 |
| 21 in. | 9.5 | 15.0 | 19.0 | 27.0 | 35.0 | 45.5 | 60.0 |
| 24 in. | 10.5 | 17.5 | 22.5 | 30.5 | 40.5 | 52.5 | 68.5 |

The flowrate of the spray color dispersion is dependent upon the gun operating pressure and the nozzle size used. The following table, Table 2, enables an operator of the system 10 to calculate spray color dispersion usage based on the nozzle tip size and pressure used.

TABLE 2
Color Flow Chart - Gallons per Minute

| TIP | | | | | | | |
|---|---|---|---|---|---|---|---|
| SIZE | 40 PSI | 50 PSI | 60 PSI | 70 PSI | 80 PSI | 90 PSI | 100 PSI |
| 0.04 | 0.25 | 0.32 | 0.38 | 0.45 | 0.50 | 0.55 | 0.60 |
| 0.05 | 0.33 | 0.41 | 0.47 | 0.52 | 0.56 | 0.61 | 0.65 |
| 0.06 | 0.41 | 0.51 | 0.57 | 0.64 | 0.69 | 0.72 | 0.74 |
| 0.08 | 0.52 | 0.64 | 0.73 | 0.81 | 0.89 | 0.95 | 1.00 |
| 0.10 | 0.60 | 0.77 | 0.89 | 0.99 | 1.08 | 1.14 | 1.20 |
| 0.15 | 0.82 | 1.05 | 1.23 | 1.37 | 1.49 | 1.60 | — |
| 0.20 | 1.02 | 1.30 | 1.50 | 1.65 | 1.79 | 1.93 | — |
| 0.30 | 1.25 | 1.57 | 1.84 | 2.09 | 2.32 | 2.64 | — |
| 0.40 | 1.58 | 2.00 | 2.32 | 2.56 | 2.69 | 2.87 | — |

The highlight can also be modified by the pattern of the spray leaving the nozzle. Various nozzles may be used to produce, among others, a solid cone, a hollow cone, or flat spray. For purposes of the present invention, spraying also may also be in the form of a stream, for example, a solid shaped stream. Again, the resulting color ultimately depends upon movement of the wet concrete from the point of spraying to the end molded unit.

The combination of any of the above setups will produce a large number of color patterns that can be readily duplicated, since it is produced by a defined, controlled setting of the variables involved, i.e., shape, position, flow and timing of the applied spray color dispersion stream.

Use of this process creates several advantages. For example, full mixer batches are used that will not slow down the production as partial batches would. Additionally, the cost of required equipment may be lower in certain cases. Finally, the highlight color pattern is easily replicated through instrument settings of the process variables.

Preferably, the spray color dispersion includes two primary parts: (1) a pigment water dispersion that contains a pigment and water and (2) a mixture of one or more of a family of polymer binding agents (discussed below) to be sprayed on wet concrete to produce a color pattern. Standard pigment water dispersions alone, as well known in the art, may be used with good results. However, since there is no substantial mixing, the pigment particles may not properly adhere to the concrete, resulting in clumps of color detaching itself from the split face of the concrete block when subjected to, for example, pressure wash.

One solution to this problem is the addition of a suitable polymer binding agent, or combination of polymer binding agents, to the color mix, which has the property, when dried, to bind the concrete and secure the pigment particles to the cement. The binding agent(s) must be insoluble in water after drying. Examples of polymer binding agents that would accomplish the above are:

Water borne urethane

acrylic emulsions

water soluble acrylic polymers

water soluble vinyl acetate

acrylic colloids

styrene acrylic resins

styrene acrylic resins solutions

acrylic copolymer latex

Certain fillers may also be included in the spray color dispersion to produce specific effects. The filler may be, for example, clay, silicates, carbonates, or barytes and may be provided in a range of, for example, about 0% to 50%. The pigment may be provided in a range of, for example, about 2% to about 60%. The polymer binding agents may be provided in a range of, for example, about 1% to about 60% (and preferably about 10% to about 30%) depending upon numerous variables. These polymer binding agent(s) have the characteristic, when sprayed, of being able to react with the wet concrete mix to form an irreversible integral structure with the pigment and the cement. A resultant polymer structure is insoluble in water and remains as part of the concrete matrix, thereby preserving the integrity of the pattern of applied color highlight.

Ranges of a spray color dispersion may be, for example, as follows:

| | |
|---|---|
| Pigment: | 2% to 60% |
| Polymer: | 1% to 60% |
| Filler: | 0% to 50% |

Any remaining percentage is water.

Tables 7, 8, 9, 10 and 11 are examples of compositions of various types of spray color dispersions, including standard and muted compositions, suitable for use in the present invention.

In each of these spray color dispersions a typical pigment water dispersion is first prepared by the standard method of mixing and milling one or more pigments (for example, 50 to 70% of the total pigment water dispersion, by weight) with water (for example, in the range of about 30 to 45%), a dispersant (for example, in the range of 1.0 to 4.0%) and a suspending agent (for example, in the range of about 0.5 to 3.0%). The pigments may be, for example, iron oxide, titanium oxide, chromium oxide or carbon. The dispersant may be, for example, BYK 156 (Amonium salt of an acrylic copolymer) by BYK Chemie, Hydropalat 44 (sodium polyacrylate) by Cognis, Troysperse W (a calcium salt of an acrylate) by Troy Chemicals or CT 136 by Air Products. The suspending agent may be, for example, Suspengel (natural bentonite) by Cimbar or Attapulgite clay (diatomacious earth) by Engelhard. A thickener, for example, CMC 7LT solution (canboxymethyl cellulose) by Aqualon or Gum Arabic by TIC may be added to the mix, for example, in the range of 0.2 to 1.2% for viscosity buildup. Other processing aid may be required such as a water softener (for example, Sequestrene), a bactericide and mildewicide or fungicide (for example, Troysan 174 and Polyphase 641 by Troy). Finally, a composition to adjust the pH of the mix may be added, such as light soda ash (LSA). It should be obvious for someone skilled in the art that many other combinations may be used to produce a typical pigment water dispersion using ingredients other than those stated above.

Tables 3, 4, 5 and 6 are examples of preferred formulas for the preparation of typical pigment water dispersions.

TABLE 3
#330 Black Dispersion

| | |
|---|---|
| Water | 33.775% |
| Sequestrene 30A | 0.20% |
| Troysperse W | 3.00% |
| Troysan 174 | 0.20% |
| Attapulgite clay | 1.20% |
| gum arabic (TIC) | 0.60% |
| Bayer 330 | 61.00% |
| (black pigment) | |
| Polyphase 641 | 0.025% |
| Total | 100% |

TABLE 4
Brown Dispersion

| | |
|---|---|
| Water | 28.325% |
| Sequestrene 30A | 0.20% |
| Hydropalat 44 | 3.00% |
| Troysan 174 | 0.20% |
| Attapulgite clay | 0.75% |
| Bayer 330 | 35.76% |
| (black pigment) | |
| Cathay HC02 | 12.90% |
| (red pigment) | |
| Cathay HC11 | 3.87% |
| (red pigment) | |
| Bayer Y25LOM | 12.47% |
| (yellow pigment) | |
| CMC 7LT Soln | 2.50% |
| Polyphase 641 | 0.025% |
| TOTAL | 100% |

TABLE 5
#130 Dark Red Dispersion

| | |
|---|---|
| Water | 24.575% |
| Sequestrene 30A | 0.20% |
| Hydropalat 44 | 3.00% |
| Suspengel dry | 0.60% |
| LSA | 0.10% |
| Cathay HC03 | 63.00% |
| (Red pigment) | |
| CMC 7LT Soln | 8.50% |
| Polyphase 641 | 0.025% |
| Total | 100% |

TABLE 6
#101 Light Red Dispersion

| | |
|---|---|
| Water | 28.725% |
| Sequestrene 30A | 0.20% |
| BYK-156 | 3.00% |
| Attapulgite clay | 0.80% |
| LSA | 0.25% |
| Cathay HC02 | 65.00% |
| (red pigment) | |
| CMC 7LT Soln | 2.00% |
| Polyphase 641 | 0.025% |
| Total | 100% |

Binding and structural agents may then be added to the prepared pigment water dispersion to create the spray color dispersion of this invention, examples of which are shown in the following tables.

TABLE 7
Dark Red Spray Color Dispersion

| | | Wt. % | |
|---|---|---|---|
| Supplier | Description | Composition | Function |
| see above | #130 Dark Red | 85% | Color Base |
| | Dispersion | | |
| Bader | Texigel 13-205l | 10% | Structural Polymer |
| | (styrenated | | |
| | acrylic polymer) | | |
| Wacker Chemie | Vinnapas 541 Z | 5% | Binding Polymer |
| | (Vinyl Acetate) | | |

TABLE 8
Light Red Spray Color Dispersion

| | | Wt. % | |
|---|---|---|---|
| Supplier | Description | Composition | Function |
| see above | #101 Light Red | 75% | Color Base |
| | Dispersion | | |
| Eng. Polymer | EPS 7221 | 10% | Structural Polymer |
| Sys. | (Acrylic Polymer) | | |
| Wacker Chemie | Vinnapas 541 Z | 5% | Binding Polymer |
| Engelhard | ASP 602 | 10% | Filler |
| | (Kaolin Clay) | | |

TABLE 9
Black Spray Color Dispersion

| Supplier | Description | Wt. % Composition | Function |
|---|---|---|---|
| see above | #330 Black | 75% | Color Base |
| | Dispersion | | |
| VIP | Accoflex 0725 | 10% | Structural |
| | (modified acrylic | | Polymer |
| | polymer) | | |
| Johnson | Joncryl 1925 | 5% | Binding Polymer |
| | (styrene acrylic | | |
| | polymer emulsion) | | |
| Engelhard | ASP 602 | 10% | Filler |

TABLE 10
Muted Black Spray Color Dispersion

| | | Wt. % | |
|---|---|---|---|
| Supplier | Description | Composition | Function |
| see above | #330 Black | 75% | Color Base |
| | Dispersion | | |
| Eng. Polymer Sys. | EPS 7221 | 10% | Structural Polymer |
| Eng. Polymer Sys. | EPS 2537 | 5% | Binding Polymer |
| | (acrylic | | |
| | polymer) | | |
| Engelhard | ASP 602 | 10% | Filler |

TABLE 11
Brown Spray Color Dispersion

| | | Wt. % | |
|---|---|---|---|
| Supplier | Description | Composition | Function |
| see above | Brown Dispersion | 60% | Color Base |
| Akzo-Nobel | #375045 | 15% | Binding Polymer |
| (proprietary | | | |
| product-acrylic) | | | |
| Engelhard | ASP 602 | 25% | Filler |

While the invention has been described in detail and with reference to specific examples thereof, it will be apparent to one skilled in the art that various changes and modifications can be made therein without departing from the spirit and scope thereof.

What is claimed is:

1. A method for producing multi-color concrete, comprising the steps of:
(a) providing a pigment water dispersion;
(b) providing a polymer binding agent;
(c) mixing the pigment water dispersion and the polymer binding agent to form a first spray color dispersion;
(d) discharging a wet concrete mix from a vessel;
(e) spraying the first spray color dispersion onto the wet concrete mix discharging from the vessel to form a pattern of applied color in the wet concrete mix; and
(f) forming a resultant structure of cured concrete.

2. The method for producing multi-color concrete according to claim 1, wherein the step of spraying includes using at least one nozzle to spray the first spray color dispersion under pressure.

3. The method for producing multi-color concrete according to claim 1, further including steps of providing a second pigment water dispersion, providing a second polymer binding agent, mixing the second pigment water dispersion and the second polymer binding agent to form a second spray color dispersion, and spraying the second spray color dispersion onto the wet concrete mix.

4. The method for producing multi-color concrete according to claim 3, wherein the steps of spraying comprise using a plurality of nozzles, wherein at least one nozzle of the plurality of nozzles sprays the first spray color dispersion and at least one nozzle of the plurality of nozzles sprays the second spray color dispersion.

5. The method for producing multi-color concrete according to claim 1, including the step of controlling a color pattern using timers that controls the step of spraying.

6. The method for producing multi-color concrete according to claim 5, wherein the step of controlling the color pattern includes spraying in pulses such that sprays of various lengths of time produce a desired pattern.

7. The method for producing multi-color concrete according to claim 1, wherein the step of spraying includes using at least one nozzle having a desired flow pattern.

8. The method for producing multi-color concrete according to claim 1, wherein the step of spraying including use of at least one nozzle includes using at least one nozzle that produces a pattern selected from the group consisting of a solid cone, a hollow cone, or a flat spray.

9. The method for producing multi-color concrete according to claim 1, wherein the step of spraying includes spraying in the form of a stream.

10. The method for producing multi-color concrete according to claim 1, wherein the step of spraying includes varying the distances between the at least one nozzle and the wet concrete mix.

11. A method for producing multi-color concrete, comprising the steps of:
(a) providing a pigment water dispersion;
(b) providing a polymer binding agent capable of integrally binding with wet concrete mix to form an irreversible integral structure of the pigment and the concrete;
(c) mixing the pigment water dispersion and the polymer binding agent to form a first spray color dispersion;
(d) discharging a wet concrete mix from a vessel;
(e) spraying the first spray color dispersion onto the wet concrete mix discharging from the vessel to form a pattern of applied color in the wet concrete mix; and
(f) forming a resultant structure of cured concrete;
whereby a resultant polymer structure is insoluble in water and remains as part of the cured concrete, thereby preserving the integrity of the pattern of applied color highlight.

12. The method for producing multi-color concrete according to claim 11, wherein the step of providing the polymer binding agent includes providing the polymer binding agent selected from the group consisting essentially of at least one of water borne urethane, acrylic emulsions, water soluble acrylic polymers, water soluble vinyl acetate, acrylic colloids, styrene acrylic resins, styrene acrylic resins solutions, and acrylic copolymer latexes.

13. The method for producing multi-color concrete according to claim 11, wherein the step of mixing includes mixing at least one filler to produce a desired effect.

14. The method for producing multi-color concrete according to claim 11, wherein the step of spraying includes using at least one nozzle to spray the first spray color dispersion under pressure.

15. The method for producing multi-color concrete according to claim 11, further including steps of providing a second pigment water dispersion, providing a second polymer binding agent, and mixing the second pigment water dispersion and the second polymer binding agent to form a second spray color dispersion

16. The method for producing multi-color concrete according to claim 15, wherein the steps of spraying comprise using a plurality of nozzles, wherein at least one nozzle of the plurality of nozzles sprays the first spray color dispersion and at least one nozzle of the plurality of nozzles sprays the second spray color dispersion.

17. The method for producing multi-color concrete according to claim 11, including the step of controlling a color pattern using timers that control the step of spraying.

18. The method for producing multi-color concrete according to claim 17, wherein the step of controlling the color pattern includes spraying in pulses such that sprays of various lengths of time produce a desired pattern.

19. The method for producing multi-color concrete according to claim 11, wherein the step of spraying includes using at least one nozzle having a desired flow pattern.

20. The method for producing multi-color concrete according to claim 11, wherein the step of spraying including use of at least one nozzle includes using at least one nozzle that produces a pattern selected from the group consisting of a solid cone, a hollow cone, or a flat spray.

21. The method for producing multi-color concrete according to claim 11, wherein the step of spraying includes spraying in the form of a stream.

22. The method for producing multi-color concrete according to claim 11, wherein the step of spraying includes varying the distances between the at least one nozzle and the wet concrete mix.

23. The method for producing multi-color concrete according to claim 11, wherein the step of providing a pigment water dispersion includes providing a pigment in a range of about 2% to about 60%.

24. The method for producing multi-color concrete according to claim 11, wherein the step of providing the polymer binding agent includes providing the polymer binding agent in a range of about 1% to about 60%.

25. A system for coloring concrete, comprising:
(a) at least one vessel containing a spray color dispersion, said spray color dispersion comprising a pigment water dispersion and at least one polymer binding agent, the at least one polymer binding agent capable of reacting with wet concrete mix to form an irreversible integral structure of the pigment and the concrete;
(b) a spray gun associated with each vessel, each spray gun connected to its associated vessel by a conduit;
(c) a pump associated with each vessel to move the spray color dispersion contained in the vessel to the spray gun associated with the vessel;
(d) an apparatus for moving fresh concrete relative to each spray gun; and
(e) a controller for controlling spraying of the spray color dispersion in each vessel through each spray gun.
